(19) United States
(12) Patent Application Publication
(10) Pub. No.: US 2006/0236847 A1
(43) Pub. Date: Oct. 26, 2006

(54) Using images as an efficient means to select and filter records in a database

(76) Inventor: Ryan L. Withop, Foster City, CA (US)

Correspondence Address: BROWN RAYSMAN MILLSTEIN FELDER & STEINER LLP, 303 TWIN DOLPHIN DRIVE, SUITE 600, REDWOOD SHORES, CA, 94065, US

(21) Appl. No.: 11/399,956

(22) Filed: Apr. 6, 2006

Related U.S. Application Data
(60) Provisional application No. 60/669,454, filed on Apr. 7, 2005.

(51) Int. Cl. G10H 7/00

(52) U.S. Cl. 84/612

(57) ABSTRACT

A method includes storing multimedia files in a database, the multimedia files in the database being associated with a plurality of groups; presenting a user with graphic elements, such that each graphic element represents a particular group of the plurality of groups; enabling the user to select a graphic element for selecting a particular one of the plurality of groups of multimedia files associated with the selected graphic element; and queuing a set of the multimedia files from the particular one of the plurality of groups of multimedia files associated with the selected graphic element for playback. The multimedia files may include songs. One of the plurality of groups may represent a particular album. The graphic element associated with the at least one of the plurality of groups may include album art representing the particular album.

### PRIORITY CLAIM TO PROVISIONAL APPLICATION

This application claims priority to and incorporates by reference U.S. Provisional Application No. 60/669,454, filed on Apr. 7, 2005, by Ryan Withop, entitled “Portable Digital Audio Player Interface to Automobile Touchscreen or Video Display Device.”

### TECHNICAL FIELD

Embodiments of the present invention relate to the field of computing, digital music, digital video, digital podcasts and/or blogs; storage and access to these data types; and processes that are used to filter data sets into smaller sets of data.

### BACKGROUND

Music and video have been evolving over the decades from medium to medium as the technology that plays and records them changes. Examples of these medium changes include the record, 8-track tape, cassette tape, Compact Disc, DVD and most recently digital files for playback by computers. Compact Discs are being replaced in cars and at home by digital music files, such as the MPEG-3 compression format, stored on portable computers such as laptops, personal digital assistants (PDAs), and MP3 players specifically used for portable music playback. Now thousands of songs can be stored on one handheld device as opposed to only one album at a time. Portable devices are also storing hundreds of video segments from broadcast television and independent internet sources. A system and method are needed to improve the ability to find and select desired music or video for playback from large collections.

### SUMMARY

As music moves from traditional mediums like Cassette Tapes and Compact Discs to digital files stored on portable computers capable of storing thousands of songs, the need to find and filter music quickly in these large music collections increases. Music is typically stored on computers in a hierarchal fashion that aids in grouping similar music; however, these lists can still number in the hundreds or thousands for users with large music collections. Systems and methods can help the user locate and recognize music more quickly and effectively.

As mobile MP3 players which store large catalogs of music move into moving vehicles such as automobiles, it becomes increasingly difficult to see and navigate the long lists of songs while driving. Screen sizes on a portable music device are typically three inches wide with nine point font. Viewing these lists for navigation on the music player requires significant time and distracts the driver from the road. A system in accordance with an embodiment of the invention converts album names to graphical images which may be duplications of the album art found on the album cover. By doing so and presenting album art on a large screen such as a seven inch screen in the dash of a vehicle, the driver may spend less time distracted from the road. In addition, since humans are many times faster at recognizing graphics than reading text and many screens built into automobiles are touch screens, a driver may select a desired album in a much shorter amount of time, significantly improving driver and passenger safety.

By filtering collection of files to a specific artist or genre of music, a user may be presented with a smaller subset of album art to choose from. By selecting directly from the album art, the music playback may be accomplished in fewer steps than scrolling through a long list of Genres and Album Names. By presenting Genres with images that relate to the specific type of music, a driver can recognize and playback an entire group of music with one touch whereby the current method would require navigating through multiple levels of text menus, taking up to 20-30 seconds of attention away from driving.

In addition to vehicle use, mobile digital music players and computers are increasingly being connected to home audio systems. When a portable music player is attached to the home audio system or “stereo”, the user is typically sitting across the room and cannot see the three inch display on the music player. He or she must go the stereo and interact with the music player to change the music. By using an external computer to control the playback and display of the music player contents and by using a remote control, the content of the music player can be displayed on a much larger display such as a television or computer monitor. Similar to the vehicle usage, there may be an advantage to seeing Genres and Albums displayed as graphical images. Many times, the name of an album is unknown and the album art is known by the user. When navigating a music collection, recognizing and selecting a name of an album in a long list can be more difficult than identifying the image associated with it.

Accessing music by Genre, artwork both assists the user in finding the music he or she most wants to hear in a fewer number of user interactions and enhances the effect of the music by stimulating the visual senses with signals that reinforce the music's undertones. Studies have shown that users are not necessarily looking for a particular artist or album of music to hear, but a song that will put them in a particular mood. By making a visual association with the mood the user wants to enjoy, it may be easier for the user to recognize this mood and the music he or she desires at that time by viewing an image.

Another application of the invention may improve selection and filtering of “podcasts”, “blogs”, and other data provided over the Internet for consumption. A podcast is an audio, mp3, or video file like a newscast that is published to a subscriber using a technology such as RSS for download over the internet. A blog is generally a segment of text, possibly supplemented with images, video, or audio segments and may also be provided to a user according to a subscription model such as the RSS feed standard. Podcasts are typically organized by artist, genre and increasingly by keyword. Since humans are better at interpreting context and remembering items by physical or visual location then by remembering specific keywords, it may be advantageous to group podcasts by a visual element such as a graphic. In one system, visual elements are used for the keywords, genre, and/or artist to facilitate selection of podcasts for playback.

In one embodiment, the present invention provides a method comprising storing multimedia files in a database, the multimedia files in the database being associated with a plurality of groups; presenting a user with graphic elements, such that each graphic element represents a particular group of the plurality of groups; enabling the user to select a graphic element for selecting a particular one of the plurality of groups of multimedia files associated with the selected graphic element; and queuing a set of the multimedia files from the particular one of the plurality of groups of multimedia files associated with the selected graphic element for playback. The multimedia files may include songs. One of the plurality of groups may represent a particular album. The graphic element associated with the at least one of the plurality of groups may include album art representing the particular album. The graphic element may include artwork representing at least one of video segments, genres, moods, tempos, styles and artists. The method may also include, before queuing the set of multimedia files, the step of enabling the user to select a subset of the particular group of multimedia files associated with the selected graphic element for playback. The method may also include, before enabling the user to select a graphic element, the step of filtering the plurality of groups to a subset of the plurality of groups from which the user selects the particular graphic element. The multimedia files may include podcasts and the groups represent keyword groupings of podcasts. The set of multimedia files may include all multimedia files of the selected particular group.

In another embodiment, the present invention may provide a system comprising a database for storing multimedia files, the multimedia files in the database being associated with a plurality of groups; a graphical interface for presenting a user with graphic elements, such that each graphic element represents a particular group of the plurality of groups; an input device for enabling the user to select a graphic element for selecting a particular one of the plurality of groups of multimedia files associated with the selected graphic element; and a program for queuing a set of the multimedia files from the particular one of the plurality of groups of multimedia files associated with the selected graphic element for playback. The multimedia files may include songs. One of the plurality of groups may represent a particular album. The graphic element associated with the at least one of the plurality of groups may include album art representing the particular album. The graphic element includes artwork may represent at least one of video segments, genres, moods, tempos, styles and artists. The input device may enable the user to select a subset of the particular group of multimedia files associated with the selected graphic element for playback. The input device may enable filtering the plurality of groups to a subset of the plurality of groups before enabling the user to select a graphic element for playback. The multimedia files may include podcasts and the groups represent keyword groupings of podcasts. The set of multimedia files may include all multimedia files in the of the selected particular group.

In still another embodiment, the present invention may provide a system comprising means for storing multimedia files in a database, the multimedia files in the database being associated with a plurality of groups; means for presenting a user with graphic elements, such that each graphic element represents a particular group of the plurality of groups; means for enabling the user to select a graphic element for selecting a particular one of the plurality of groups of multimedia files associated with the selected graphic element; and means for queuing a set of the multimedia files from the particular one of the plurality of groups of multimedia files associated with the selected graphic element for playback.

### BRIEF DESCRIPTION OF THE DRAWINGS

FIG. 1 shows a system showing a portable computer with a display and audio port for listening to music, in accordance with an embodiment of the present invention.

FIG. 2 shows a system in which a separate computer, called the “controller.” and remote input device control a portable computer containing the music collection, in accordance with another embodiment of the present invention.

FIG. 3 shows details of a portable computer including files, databases, and associated electronics to display music data.

FIG. 4 shows the music database including an MP3 file and external data.

FIG. 5 shows album art gathered from a networked database or via user input and stored on a computer.

FIG. 6 shows various software components to display album art and queue songs for playback.

FIG. 7 shows a hierarchal structure of an MP3 file and the use of images to filter database results for easy playback.

### DETAILED DESCRIPTION

As music moves from traditional mediums like Cassette Tapes and Compact Discs to digital files stored on portable computers capable of storing thousands of songs, the need to find and filter music quickly in these large music collections increases. Music is typically stored on computers in a hierarchal fashion that aids in grouping similar music; however, these lists can still number in the hundreds or thousands for users with large music collections. Systems and methods can help the user locate and recognize music more quickly and effectively.

As mobile MP3 players which store large catalogs of music move into moving vehicles such as automobiles, it becomes increasingly difficult to see and navigate the long lists of songs while driving. Screen sizes on a portable music device are typically three inches wide with nine point font. Viewing these lists for navigation on the music player requires significant time and distracts the driver from the road. A system in accordance with an embodiment of the invention converts album names to graphical images which may be duplications of the album art found on the album cover. By doing so and presenting album art on a large screen such as a seven inch screen in the dash of a vehicle, the driver may spend less time distracted from the road. In addition, since humans are many times faster at recognizing graphics than reading text and many screens built into automobiles are touch screens, a driver may select a desired album in a much shorter amount of time, significantly improving driver and passenger safety.

By filtering collection of files to a specific artist or genre of music, a user may be presented with a smaller subset of album art to choose from. By selecting directly from the album art, the music playback may be accomplished in fewer steps than scrolling through a long list of Genres and Album Names. By presenting Genres with images that relate to the specific type of music, a driver can recognize and playback an entire group of music with one touch whereby the current method would require navigating through multiple levels of text menus, taking up to 20-30 seconds of attention away from driving.

In addition to vehicle use, mobile digital music players and computers are increasingly being connected to home audio systems. When a portable music player is attached to the home audio system or “stereo”, the user is typically sitting across the room and cannot see the three inch display on the music player. He or she must go the stereo and interact with the music player to change the music. By using an external computer to control the playback and display of the music player contents and by using a remote control, the content of the music player can be displayed on a much larger display such as a television or computer monitor. Similar to the vehicle usage, there may be an advantage to seeing Genres and Albums displayed as graphical images. Many times, the name of an album is unknown and the album art is known by the user. When navigating a music collection, recognizing and selecting a name of an album in a long list can be more difficult than identifying the image associated with it.

Accessing music by Genre, artwork both assists the user in finding the music he or she most wants to hear in a fewer number of user interactions and enhances the effect of the music by stimulating the visual senses with signals that reinforce the music's undertones. Studies have shown that users are not necessarily looking for a particular artist or album of music to hear, but a song that will put them in a particular mood. By making a visual association with the mood the user wants to enjoy, it may be easier for the user to recognize this mood and the music he or she desires at that time by viewing an image.

Another application of the invention may improve selection and filtering of “podcasts”, “blogs”, and other data provided over the Internet for consumption. A podcast is an audio, mp3, or video file like a newscast that is published to a subscriber using a technology such as RSS for download over the internet. A blog is generally a segment of text, possibly supplemented with images, video, or audio segments and may also be provided to a user according to a subscription model such as the RSS feed standard. Podcasts are typically organized by artist, genre and increasingly by keyword. Since humans are better at interpreting context and remembering items by physical or visual location then by remembering specific keywords, it may be advantageous to group podcasts by a visual element such as a graphic. In one system, visual elements are used for the keywords, genre, and/or artist to facilitate selection of podcasts for playback.

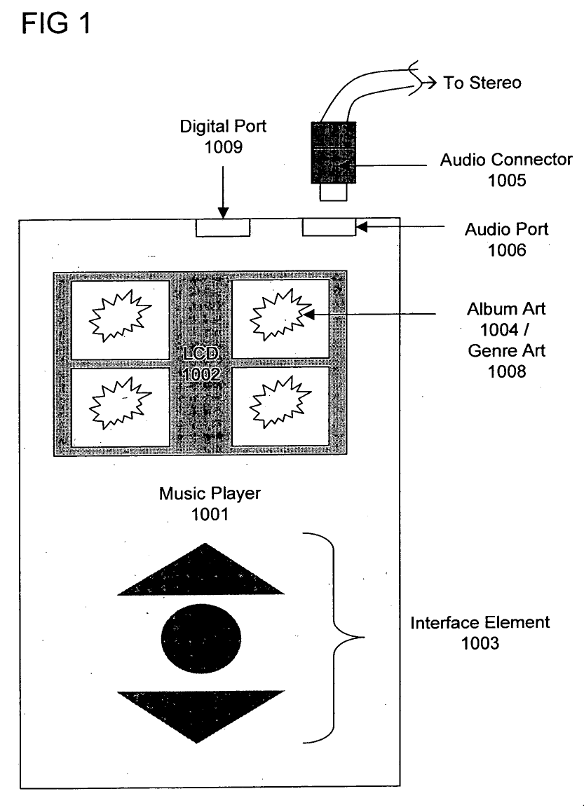

Referring to FIG. 1, a Music Player 1001 is shown. The music player 1001 is a computer used for processing data and performing calculations, and includes a Liquid Crystal Display (LCD) 1002, used to display information to a user, an Interface Element 1003 such as buttons to instruct the Music Player 1001 what to do, and graphic elements called Album Art 1004 displayed on the LCD 1002, e.g., representing a duplication of the artwork found on the front cover of a specific album of music. The image in this example could have similarly been Genre Art 1008 which is an image that has visual elements related to that particular style of music. An Audio Connector 1005 carries an analog audio signal back to a speaker for listening to music when plugged into the Audio Port 1006 which transmits the audio signal. Digital Port 1009 may be utilized in an embodiment where an external computer is used to playback music and/or control the Music Player 1001. In this case, the Digital Port 1009 is a digital communications port such as a Universal Serial Bus (USB) or proprietary connection format, including potential wireless communication strategies. In this embodiment, the Music Player 1001 is a portable computer, such as a Personal Digital Assistant (PDA) or portable music player, which is a popular player as this is where digital music is popularly stored. However, other embodiments of the Music Player 1001 include embedded computers, laptop computers, personal home computers, cell phones, video players, etc. Additionally, another embodiment of the Interface Element 1003 may include a remote control or a touch screen interface which interprets user requests based upon the position of the user's finger against the screen or a remote control device.

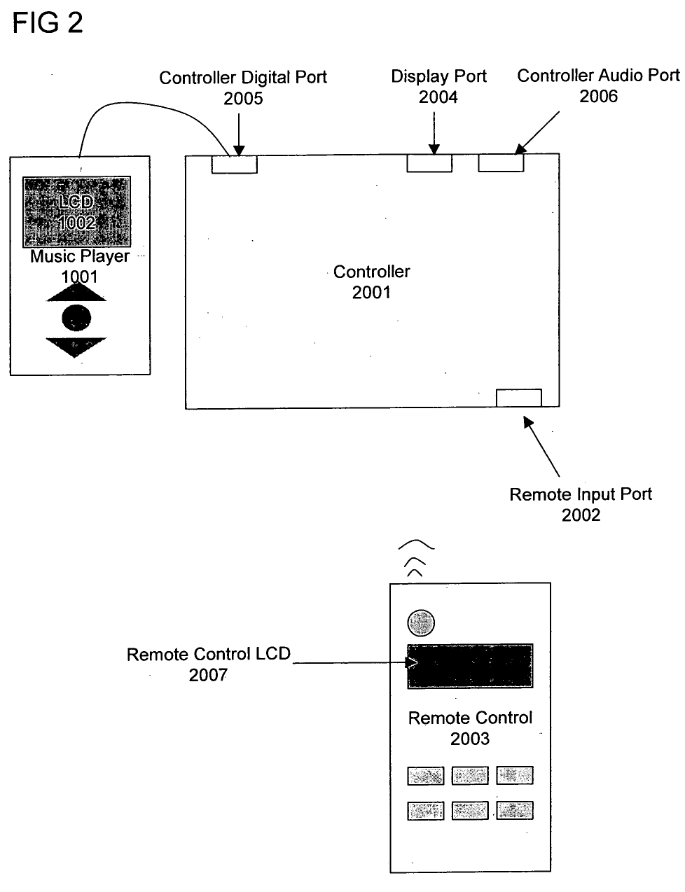

Referring now to FIG. 2, the Music Player 1001 is in a digital communication with another computer called the Controller 2001 which controls the display and playback of music files stored on the Music Player 1001. The Controller 2001 contains a Remote Input Port 2002 which receives user requests through technologies such as Infrared, Radio Frequency, Bluetooth, and/or WiFi from the Remote Control 2003. The Controller 2001 also may contain a Display Port 2004 for sending video output to an external video device such as a television and may contain a Controller Audio Port 2006 for playback of the music that is streamed digitally from the Music Player 1001. The Controller Digital Port 2005 allows commands to be sent to control the Music Player 1001 and receives a digital stream of audio for playback through the Controller Audio Port 2006. In the embodiment in FIG. 1, the audio is played through the Audio Port 1006 of FIG. 1 on the Music Player 1001 itself.

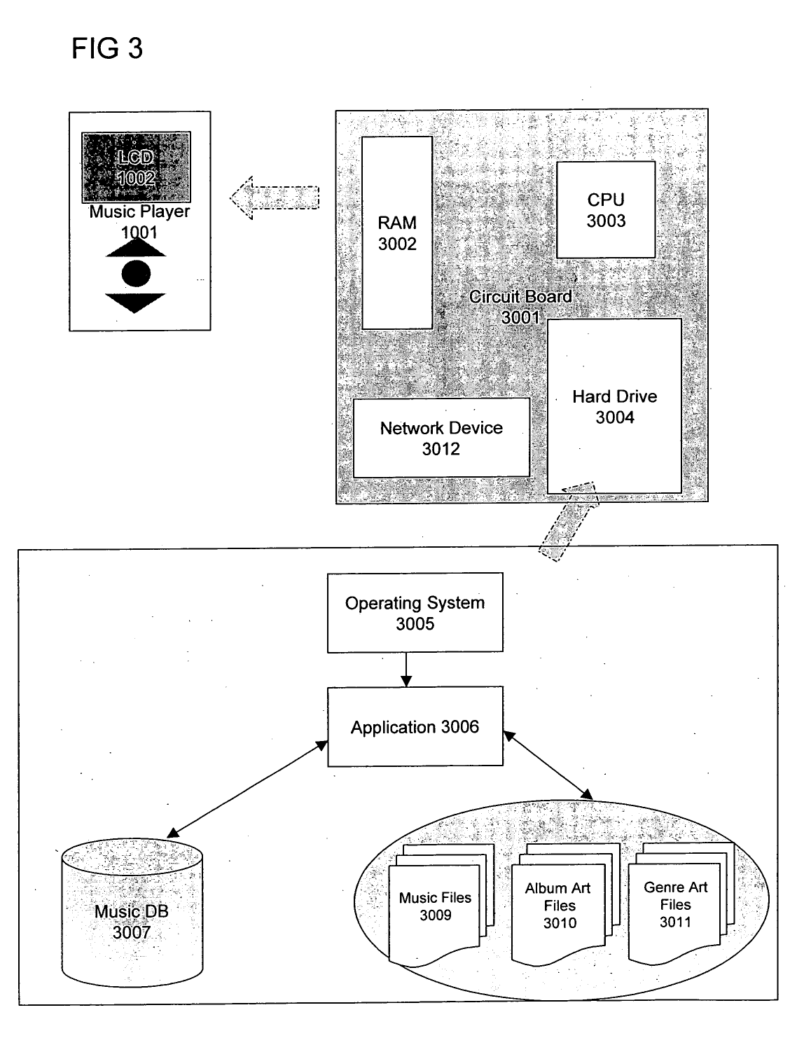

Referring now to FIG. 3, the Music Player 1001 contains a Circuit Board 3001 which carries electrical signals to make a computer function, Random Access Memory (RAM) 3002 which temporarily holds information or “data” in memory, a Central Processing Unit (CPU) 3003 which computes values and passes those values to other circuits on the circuit board via electrical signals, and a Hard Drive 3004 which permanently stores information such as data files. In another embodiment, the Hard Drive 3004 may be replaced with or include other types of permanent storage such as a flash drive. In this embodiment, the Audio Port 1006, Display Port 2004, and Remote Input Port 2002 are also contained on the Circuit Board 3001. An Operating System (OS) 3005 controls various circuits and provides a platform for applications to run. An Application 3006, sometimes referred to as a “Program” is a set of executable computer code that runs on an OS 3005 and provides the user a way to interact with the Music Player 1001 or Controller 2001 and perform particular functions on his or her behalf. A Database is a structured way of holding data and determining relationships between the data for easy retrieval and in our case is referred to as a Music Database (Music DB) 3007. Files contain data and are generally stored on a Hard Drive 3004 for later retrieval. In this system, there are Music Files 3009 which contain audio data, Album Art Files 3010 which contain graphical duplications of album covers called Album Art 1004, Genre Art Files 3011 which are similar graphic representations of a particular type of music, and files that are needed by the applications to process user requests, display results, and playback the music. The Application 3006 uses the Music Database 3007 to locate a particular Album Art File 3010 and Music File 3009 for display and playback, respectively. In this embodiment, the files and databases reside on the Music Player 1001. In other embodiments, the Application 3006, Music Database 3007 and even Album Art Files 3010 may reside on a Controller 2001. The Network Device 3012 provides a means for the Music Player 1001 to communicate to the Internet to retrieve or send additional data. Typically, this is in the form of a Network Interface Card (NIC). The Network Device 3012 may instead exist on the Circuit Board 3001 of the Controller 2001.

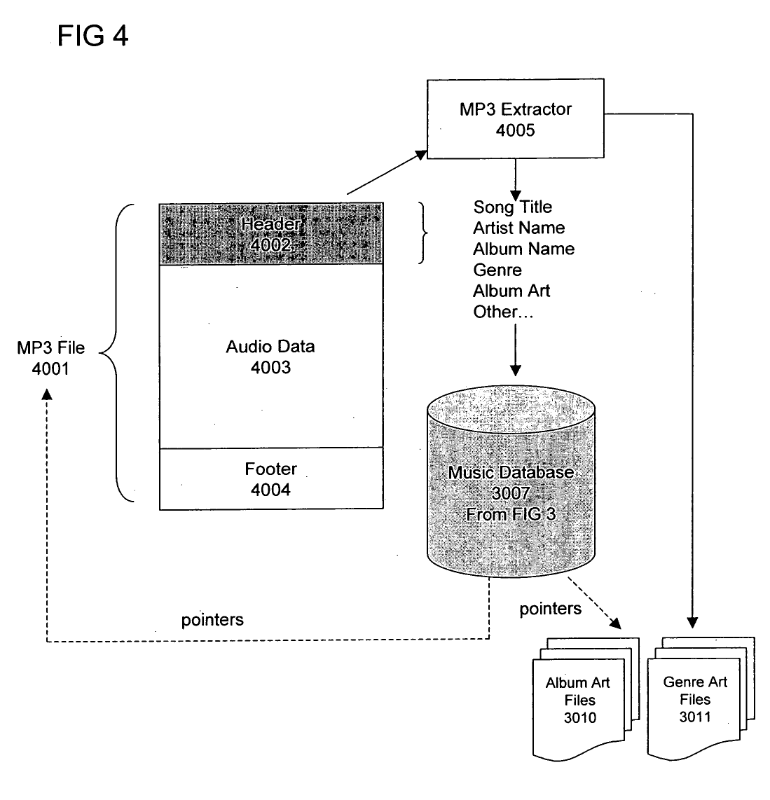

Referring now to FIG. 4, an MP3 File 4001 is a type of file that uses a compression routine to store audio data on a computer in a smaller memory allocation. An MP3 File 4001 also contains space for a Header 4002 which contains user specified data about the file. This data may be in the format of text or a data set containing the Album Art 1004 from FIG. 1. Typically, this text data includes the song title, artist name, and album name, and genre, which is entered by the user. There may be additional data stored in the Header 4002 not specified here. Typically, the header data is contained in a structure known as ID3, although other forms of storing the data are acceptable. In addition, other embodiments of the audio file do not have to be in the form of an MP3 file but can use other file types such as Windows Media Audio (WMA) or additional file types that use other methods for data reduction but still apply similar rules to storing data about the file in a Header 4002. The Audio Data 4003 is the memory allocation of the audio content. There is also typically a Footer 4004 which stores information about the file. MP3 Files 4001 are stored as files on the Music Player 1001 Hard Drive 3004. The MP3 Extractor 4005 is an Application 3006 which reads and parses the data contained in the Header 4002 of an MP3 File 4001, using a programming language such as C++ and industry standard interfaces for accessing ID3 formatted data, understood by those skilled in the art. The MP3 Extractor 4005 takes items such as the song title, artist name, album name, genre name, and other optional fields and stores the information in the Music Database 3007. If Album Art 1004 is found in the Header 4002, then in one embodiment, the Album Art 1004 is stored as a graphics file on the Hard Drive 3004 of the Music Player 1001 in a location that can be accessed by the either applications on the Music Player 1001 or the Controller 2001. In another embodiment, the Album Art 1004 may be stored directly in the Music Database 3007. Regardless of location, the MP3 Extractor 4005 may store a pointer to the memory location of the Album Art 1004 and may establish a pointer to the MP3 File 4001 in the Music Database 3007. The MP3 Extractor 4005 also inserts the path to the Genre Art 1008 that matches the Genre listed in the MP3 File 4001. It does this by comparing genre names found in an external XML file and its corresponding path to Genre Art 1008 located on the Hard Drive 3004 of the Music Player 1001, or in another embodiment the Hard Drive 3004 of the Controller 2001.

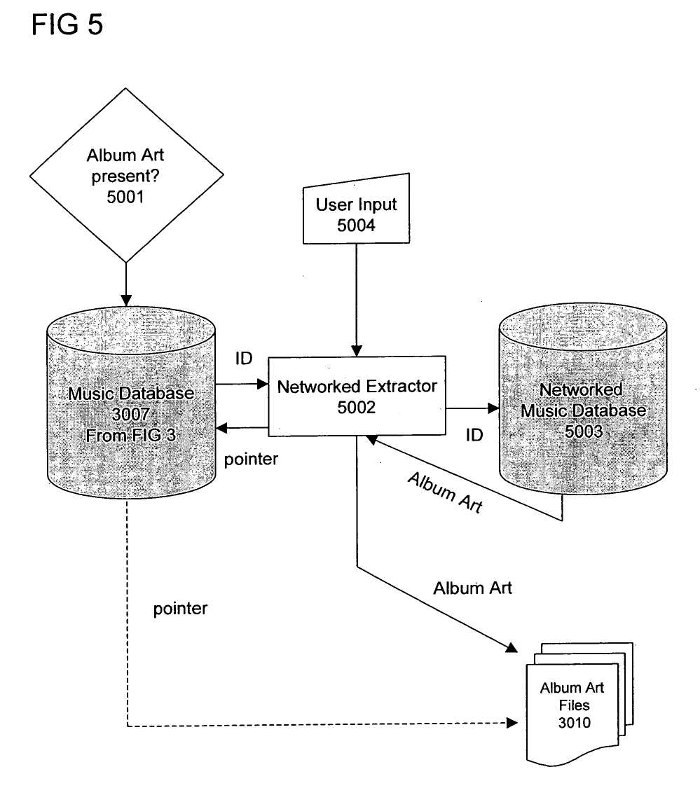

Referring now to FIG. 5, the Networked Extractor 5002 which is another Application reads the Music Database 3007 to identify which albums do not have pointers to Album Art 1004 as indicated by the Album Decision Function 5001. If no Album Art 1004 is found the Networked Extractor 5002 uses an established programming interface to communicate with the Networked Music Database 5003. The Networked Music Database 5003 receives requests from the Networked Extractor 5002 in the form of a unique identifier for a particular song. This identifier can be a unique alphanumeric string, a combination of text value such as song title and artist name, or a unique segment of the song's audio that is used to compare against the Networked Music Database 5003 to identify the appropriate Album Art 1004. This Networked Music Database 5003 is typically stored on a remote computer accessed via internet protocols and the Network Device 3012; however, another embodiment allows the Networked Music Database 5003 to be stored either on the Music Player 1001 or more likely the Controller 2001. This is accomplished using an Applications Programming Interface (API) supplied by the provider of the Networked Music Database 5003. The Networked Music Database 5003 then returns the Album Art 1004 if a match is found and the Networked Extractor 5002 saves the Album Art 1004 as a file on the Music Player 1001 Hard Drive 3004 and inserts a pointer to the memory location of the Album Art 1004 in the Music Database 3007 by means of a SQL query insertion statement. There are times at which the user may want to override the art provided to them for an album or a particular genre of music. User Input 5004 is when the user provides input into the database in the form of a pointer to a graphic of his or her choosing. This is especially useful when assigning a graphic to a pre-established, user Playlist (a user-defined group of music). The Networked Extractor 5002 then writes a SQL INSERT query to insert the path or pointer to the specified graphic in the same record as the chosen album, genre, or playlist.

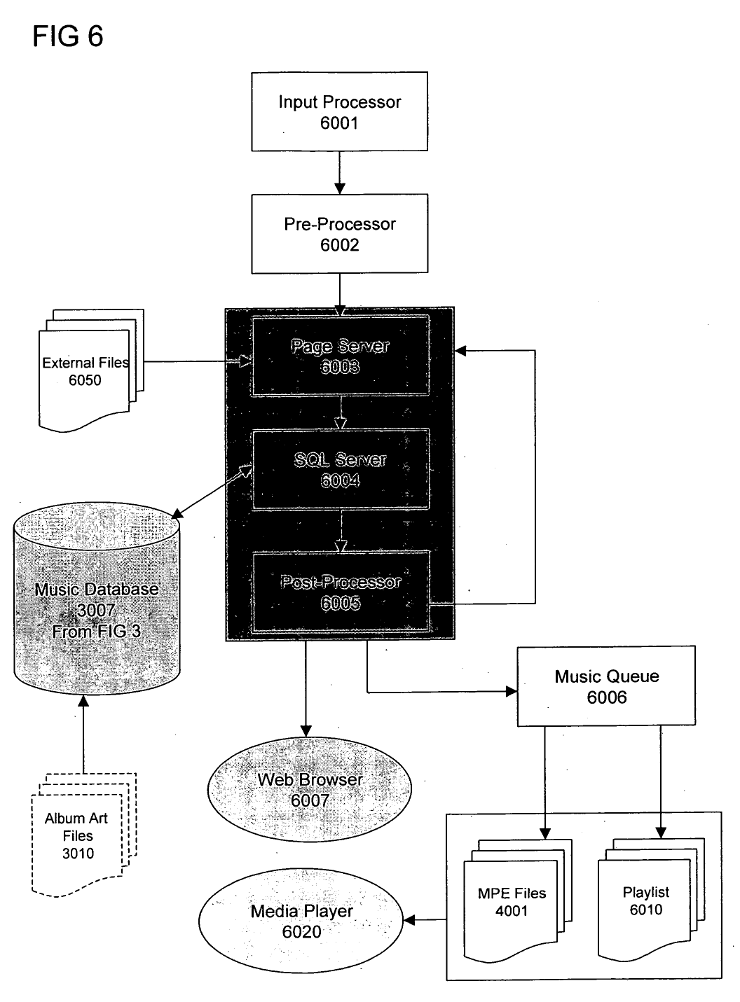

Referring now to FIG. 6, there are many Applications 3006 which interact with each other on the Operating System 3005 to interpret the user's request and display and/or playback the requested music. In this embodiment, each function, referring to each as an Application, may be separated. In another embodiment, all of these functions can be incorporated into a single Application 3006. In general, each application shown is run in the order top down and passes information to the next module below it until the results are displayed to the user. In this embodiment, the first Application is the Input Processor 6001. The function of the Input Processor 6001 is to receive requests from the user and send the appropriate command to the next application which can act on this request. When the user pushes a button using the Interface Element 1003, the Input Processor 6001 receives this request as a stream of data. It then interprets this data and in this embodiment sends a character or a series of characters to the Pre-Processor 6002. The Pre-Processor 6002 is a software application which receives the characters and compares those to an established list of acceptable characters. If a match is found, the Pre-Processor 6002 sends a request for action to the Page Server 6003. The Page Server 6003 is an application and in this embodiment is a dynamic web server that performs the action required and displays the results to the user on the LCD 1002 or external video device. In one embodiment, the Page Server 6003 uses established web technology provided by the Operating System 3005. Other embodiments allow the Page Server 6003 to be an application written in other programming languages such as C++ and Java. The Page Server 6003 may use External Files 6050 to format the display of the requested information such as XML and Cascading Style Sheets (CSS) and also uses the Pre-Processor to construct queries to the SQL Server 6004. The SQL Server 6004 is an application which receives requests for data, compares those searches with values in the Music Database 3007 and then returns the results to the Page Server 6003. A Post-Processor 6005 revises the data and format of the results from the SQL Server 6004 before the Page Server 6003 processes the information for display. The Post-Processor 6005 also provides feedback to the user by changing the appearance of various elements on the web page when the user interacts with them. The Post-Processor 6005 also sends the final command to the next module to either display the album contents or queue for playback. In this embodiment, the Page Server 6003 returns a complete web page for display by a Web Browser 6007 which is an application that displays web pages using established technology on the Operating System 3005. The Pre-Processor 6002 may request action from the Music Queue 6006 application, which stores a list of music in a queue for playback. The Music Queue 6006 sends the path to the requested song to the Media Player 6020 which handles opening the MP3 File 4001 for audio playback. The Media Player 6020 may exist on the Music Player 1001 or may use the Digital Port 1009 to communicate with the Controller 2001 which contains the Media Player 6020 and a Controller Audio Port 2006 for the actual music playback. In another embodiment, the Music Queue 6006 writes out a text file called a Playlist 6010 in an established format to be read by the Media Player 6020 which will handle playback of the songs in a queue according to the order in the Playlist 6010.

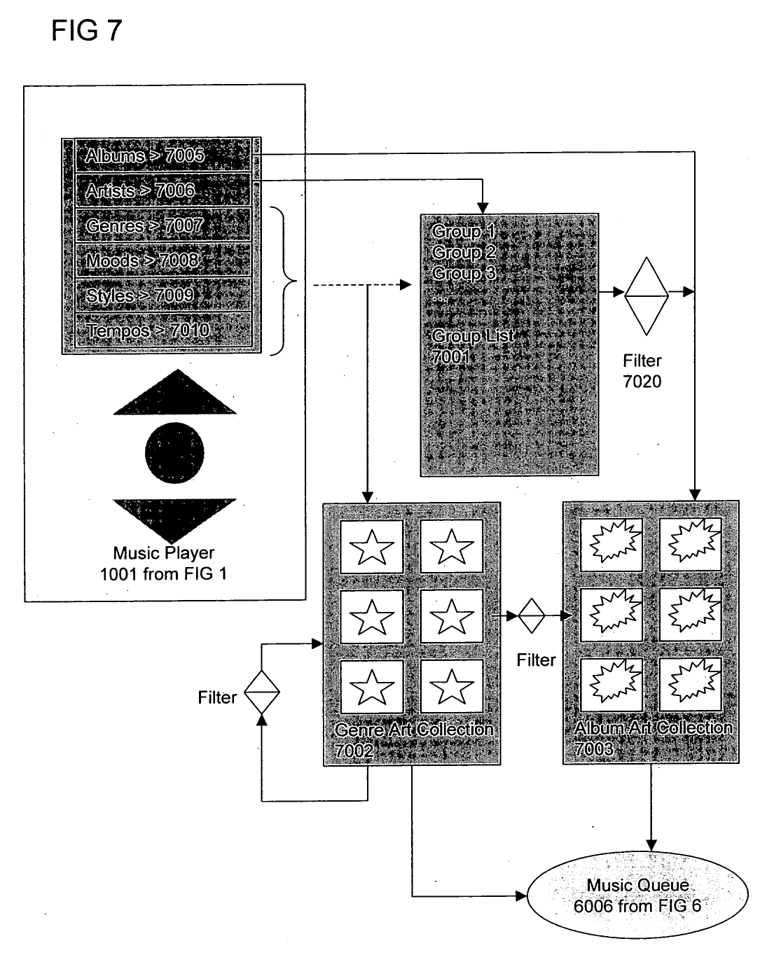

Referring now to FIG. 7, a hierarchal structure is employed to group songs on a Music Player 1001. This acts as a means to filter the number of songs returned to the user based upon similar groupings of songs. The main menu presented to the user shows a list of collections that group songs by their characteristics such as artist name, genre, and tempo. The Albums Collection 7005 when selected will display an unfiltered view of the Album Art Collection 7003 showing every album in the Music Database 3007. The Artists Collection 7006 contains a collection of artists' names found in the Music Database 3007. When the Artists Collection 7006 is selected, a Group List 7001 will be presented listing all of the artists names found in the Music Database 3007. When a particular artist name is selected from the Group List 7001, a request is sent to return only albums and Album Art 1004 by the requested artist. This request acts as a Filter 7020 to the display. The resulting display to the user is an Album Art Collection 7003 containing each matching Album Art File 3010 found in the Music Database 3007. Genres Collection 7007 is a grouping of music based upon an agreed similar style of music. Similar groupings include Moods 7008 which indicate the feel of a particular song, Styles 7009 which indicate a more particular style of music than Genres 7007, and Tempos 7010 which describe the average speed of the music. A Genre Collection 7007 can be represented by a Group List 7001 too, containing the names of all of the genres found in the Music Database 3007. This system improves the selection process by representing genres instead with a Genre Art 1008 in a Genre Art Collection 7002. This improvement helps the user recognize the type of music he or she wants faster by associating the mood with visual undertones of that genre. The Genre Art Collection 7002 shows all of the genres present in the Music Database. When a particular Genre Art 1008 element is selected, based upon the particular Interface Element 1003 chosen, the Music Queue 3006 plays all of the songs in that genre. In another embodiment, the selection of the genre art displays a list of songs that can be further selected for playback. Moods 7008, Styles 7009 and Tempos 7010 use the same paradigm as the Genre Collection 7007 using graphical elements that mimic the mood or style as a filter to enable better grouping and selection of music.

Again, while music has been used as the example in this embodiment, this same grouping can be applied to video segments or podcasts organized by keyword. It can be quite beneficial to group podcasts and video programs by keyword graphic, especially if these programs are in a large collection or are played on a long automobile commute in which selection time needs to be minimized.

Walking through an example user flow of selecting an album from a particular artist goes as follows: The user sees displayed on the LCD 1002 a main menu allowing selection from one of the collections in the hierarchy presented in FIG. 7. The user selects from this menu “Artists” and is then presented with a list of artists found in the Music Database 3007. The user moves through this menu down to a desired artist and selects the particular artist. The Album Art 1004 is returned in an Album Art Collection 7003 for display on the LCD 1002. The user selects a particular album for playback or display by using the Interface Elements 1003 to move the cursor to the Album Art 1004 that matches the album of interest. When selected by the user, the album will play on the Media Player 6020 or be displayed depending on which Interface Element 1003 the user has depressed. A Music Queue 6006 listing is then presented to the user on the LCD 1002 displaying the contents of the song playing and songs ready for playback. This same technique is applied to Genres, Moods, Styles, and Tempos.

Describing this process in more detail, the Page Server 6003 displays a list of hierarchal groupings of music such as artist and genres on the LCD 1002 by showing a specific web page inside a Web Browser 6007. The user moves down this list using buttons on the Interface Element 1003 or on a Remote Control 2003 Device. The Input Processor 6001 receives this request via electrical signal or via a USB Infrared or RF receiver and compares it to an Extensible Markup Language (XML) file which contains a list of command pairs. If an acceptable command was found in the list, the Input Processor 6001 sends out the corresponding keystroke or series of characters to the Pre-Processor 6002. An example XML file statement is as follows:

<Key KeyState=”Down” KeyPressed=”Play”><ACTION
Target=WebBrowser>SendKeys = “p”</ACTION></Key>

The Pre-Processor 6002 receives the keystrokes and compares to a modified list of commands. If a match is found the Pre-Processor request a web page be opened by the Page Server 6003 by using a (Unified Resource Locator) URL string with variables passed using the HTTP GET Method. An example code is as follows:

<SCRIPT Language=Javascript>
Select Case “p”

“document.location =
http://localhost/artists.html?var1=ArtistName”.

End Select
</SCRIPT>

Another embodiment includes passing the requested information by the HTTP POST Method. The Page Server 6003 dynamically processes the code presented in the requested web page. This code may be in the format of JavaScript programming language, PHP, SQL queries, HTML and XML, web based languages understood by someone knowledgeable in the art of web design. In another embodiment, the Page Server 6003 is not a dynamic web server but an application written in a programming language such as C++. When the Page Server 6003 encounters this code it connects with the Music Database 3007 and prepares a SQL query. Before it can create a query or display, the Page Server 6003 must parse the URL string sent in the HTTP GET Method or read any cookie variables passed to the page. This is easily understood by any one skilled in the art of dynamic web page creation. The variables in the URL string are parsed and passed to the Pre-Processor 6002 to construct a valid query to the SQL Server. The SQL Server 6004 receives the SQL query, accesses the Music Database 3007 using established database connection routines and returns the results to the Page Server 6003 before the page is displayed. An example SQL query is as follows:

“sql = SELECT album_id, album_name, album_url FROM artists WHERE
artist=’ArtistName’ GROUP BY AlbumName”

where the ArtistName may have been passed in the URL string by the Pre-Processor 6002. The Page Server 6003 then applies the formatting found in the HTML of the web page and uses associated External Files 6050 from FIG. 6 such as Cascading Style Sheets (CSS) to format the results for display. The Post-Processor 6005 reviews the results and modifies the display as needed. An example of a Post-Processor 6005 function is when no records were returned from the SQL Server 6004 it may read the “NUM_RECORDS” field sent by the SQL Server 6004 and if found to be equal to zero it will use JavaScript in the web page to write out text indicating “No Records Found” or if only one record was returned from the Music Database 3007 it may choose to redirect the page server to open a new web page containing the contents of the sole album. When a particular artist has been selected by the user, the result of the SQL query will be the name of the album and the location of the Album Art 1004 on the Hard Drive 3004 corresponding to all artists with the name selected by the user input. Typically, the Music Database 3007, Music Files 309, and Album Art Files 3010 are all stored on the Hard Drive 3004 of the Music Player 1001 and are either accessed by applications on the Music Player 1001 or on the external Controller 2001. The Page Server 6003 receives the album data and writes out an HTML code that generates the display of each Album Art 1004, by performing a programming loop, using PHP language, of the following code until the number of returned records has been reached:

“<IMG ID=album_id ALT=album_name SRC=album_url>”.

Instead of HTML code, another embodiment could use a graphic object in C++ or Java code with its source pointed to the location of the Album Art File 3010. A combination of JavaScript and Dynamic Hypertext Markup Language (DHTML) and CSS in the Post-Processor 6005 is used to reformat the web page displayed as the user changes focus from one element to another. In addition, when an album is selected, the Post-Processor 6005 handles the construction of the next web page to be requested by the Page Server 6003. It does this by determining which album was selected, by reading the ID tag of the IMG element on the web page when the keypress or mouse event occurred. The Post-Processor 6005 then constructs a SQL query using JavaScript and inserting:

“WHERE album_id=album_id_selected”.

The Post-Processor 6005 then decides whether to display the contents of the album by requesting a web page that has those instructions or to queue the album for playback. This is done by receiving the request from the user's actions with the Interface Elements 1003 from the Pre-Processor 6002. If the user has pushed the “Display” button on the Interface Element 1003 than the Post-Processor 6005 with the help of the Pre-Processor 6002 constructs a URL string that calls a web page with the instructions to retrieve that album from the SQL Server 6004 and display according to formatting in the web page and associated CSS. If the Pre-Processor 6002 indicates that the “Play” button was depressed by the user, a different SELECT CASE SWITCH in JavaScript will be followed to construct a URL request with a SQL query that invokes the Music Queue 6006. An example URL request to play the album selected goes as follows:

“document.location =
http://localhost/queue.html?albumID=94305438&action=play;”

The Music Queue 6006 application orders the songs from an album into a list for queuing and then plays the appropriate song by opening its MP3 File 4001 in the Media Player 6020 Application, which is capable of MP3 and similar compressed file format playback. This is accomplished by parsing the URL string or cookie variables to determine the ID of the album requested for playback. The Music Queue 6006 then creates a SQL query to find a matching album_id in the Music Database 3006. When a match is found, the Music Queue 6006 receives the resulting list of songs in that album including the song_id field and the field containing the path or pointer to each MP3 File 4001 stored in the Music Database 3006. The song is then opened and plays the audio portion of the MP3 File 4001. The queue of songs is maintained in memory by the Music Queue 3006, but in another embodiment can pass the path to each song in a text file as an ordered list, called a Playlist 6010. Playlists 6010 are text files written in a specific sequence of data and are commonly accepted by software capable of playing MP3 Files 4001. Playlist 6010 files such as a “.pls” provide the queue of songs to be played back and typically hold the song title, artist name, and a path to the music file to be played separated by comma characters. Each song is typically written on its own line with a carriage return at the end. If the Music Queue 6006 application resides on the Controller 2001 as opposed to the Music Player 1001, the Music Queue 6006 application sends a request along the Digital Port 1009 using the proprietary stream of data to control the playback and open the MP3 File 4001 on the Music Player 1001. In this example we used Artist Name as a filter such that only Album Art by the chosen artist would be displayed. Otherwise every Album Art 1004 found in the Music Database 3006 would have been displayed. This example also applies similarly to user requests to filter the music by Genre, Mood, Style, and Tempo or other grouping of music data.

Another mode of operation is selecting music by Genre Art 1008. Genres can themselves be represented as graphical images. Genre Art 1008 is an image that represents culturally accepted icons, photos, or representations of people, places or things that belong visually to a particular type of music. An example would include pictures of New Orleans with a Saxophone to represent the Genre called Jazz. When a user selects Genres from the main menu, a collection of Genre Art 1008 is presented to the user in on the LCD 1002. Each Genre Art 1008 represents a single Genre found in the Music Database 3007. Similar to how artist filtering works as described in FIG. 7, a SQL query is constructed on the web page for Genres. The SQL query may be as follows:

“sql = SELECT genre_id, genre_name, genre_url FROM Genres”.

This selects the genre name and a pointer to the Genre Art 1008 found in the Genre table of the Music Database 3007. The user then interacts with the Interface Element 1003, selects the Genre Art 1008 of interest, the ID object in the IMG tag of the Genre Art 1008 is noted when the keypress event occurs in the Web Browser 6007. This ID is the Genre ID and is sent as variable in the HTTP GET Method which requests a page from the Page Server 6003 to retrieve all of the songs matching that genre ID. An example request looks like the following:

“document.location = http://localhost/queue.html?genre=189374834;”

This calls the Music Queue 6006 to prepare either a Playlist 6010 for the Media Player 6020 or to queue the selected songs in a stack and open the first MP3 File 4001 using the Media Player 6020. Alternatively, the user could have selected to display the contents of that genre by depressing a different button on the Interface Element 1003. This would have generated a different page request, such as:

“document.location = http://localhost/genre.html?genre=189374834;”

which would display the Album Art 1004 for all albums in the Music Database 3007 that have a corresponding Genre value equal to the requested Genre. An example query is as follows:

“sql = SELECT album, album_url FROM Genres where
GenreID =’ID’ GROUP BY
GenreName”.

The Page Server 6003 then follows a series of similar steps to those presented in FIG. 8 for the artist filter by using the Post-Processor 6005 to retrieve albums or songs that match the Genre by utilizing the event handler to determine the ID of the IMG element that was selected and pass this into a SQL query. In another embodiment using the external Controller 2001, the Web Browser 6007 contents may display on an external video source such as a television by converting the video into a video signal which is transmitted out the Display Port 2004 on the Controller 2001. Moods 7008, Styles 7009, Tempos 7010, Artists 7007, and even user pre-defined Playlists 6010 can be represented by Genre Art 1008. A user can define his or her own artwork to be associated with each to allow quicker recognition of that particular group of music. An example is one in which a user has created his own Playlist 6010 called “George's Driving Music”. The user previously stored a Genre Art File 3011 on the Music Player 1001 and inserted a path to this Genre Art File 3011 using the Networked Extractor 5002 application, assigning this graphic to “George's Driving Music” Playlist 6010. Subsequently, each time the user navigates to the Playlist collection, he or she will see Genre Art 1008 associated with each particular Playlist 6010 including the one mentioned above. This picture can be selected, to queue this entire set of music for playback.

In addition, each high level collection can be combined. For instance a user may select a mood and a genre to queue music. An example might be for a user to select Genre Art 1008 that represents “Romantic” mood and is then presented with Genre Art 1008 for genres in which the user selects “Hard Rock.” In this case all of the “Romantic Hard Rock” would be queued for playback. Another example is one in which the user selects an album by Album Art 1004 and then from a grouping such as mood using Genre Art 1008 in order to select a much more filtered list of music for playback

These same grouping of music can be applied to video segments and podcast data, whether audio or video. A graphic representing that piece of data, can be stored on a Hard Drive 3004 and used for selection if an ID and a pointer to that file are assigned in the Music Database 3007.

1. A method comprising:
storing multimedia files in a database, the multimedia files in the database being associated with a plurality of groups;
presenting a user with graphic elements, such that each graphic element represents a particular group of the plurality of groups;
enabling the user to select a graphic element for selecting a particular one of the plurality of groups of multimedia files associated with the selected graphic element; and
queuing a set of the multimedia files from the particular one of the plurality of groups of multimedia files associated with the selected graphic element for playback.

2. The method of claim 1, wherein the multimedia files include songs, at least one of the plurality of groups represents a particular album, and the graphic element associated with the at least one of the plurality of groups includes album art representing the particular album.

3. The method of claim 1, wherein the graphic element includes artwork representing at least one of video segments, genres, moods, tempos, styles and artists.

4. The method of claim 1, further comprising, before queuing the set of multimedia files, enabling the user to select a subset of the particular group of multimedia files associated with the selected graphic element for playback.

5. The method of claim 1, further comprising, before enabling the user to select a graphic element, filtering the plurality of groups to a subset of the plurality of groups from which the user selects the particular graphic element.

6. The method of claim 1, wherein the multimedia files include podcasts and the groups represent keyword groupings of podcasts.

7. The method of claim 1, wherein the set of multimedia files includes all multimedia files of the selected particular group.

8. A system comprising:
a database for storing multimedia files, the multimedia files in the database being associated with a plurality of groups;
a graphical interface for presenting a user with graphic elements, such that each graphic element represents a particular group of the plurality of groups;
an input device for enabling the user to select a graphic element for selecting a particular one of the plurality of groups of multimedia files associated with the selected graphic element; and
a program for queuing a set of the multimedia files from the particular one of the plurality of groups of multimedia files associated with the selected graphic element for playback.

9. The system of claim 8, wherein the multimedia files include songs, at least one of the plurality of groups represents a particular album, and the graphic element associated with the at least one of the plurality of groups includes album art representing the particular album.

10. The system of claim 8, wherein the graphic element includes artwork representing at least one of video segments, genres, moods, tempos, styles and artists.

11. The system of claim 8, wherein the input device enables the user to select a subset of the particular group of multimedia files associated with the selected graphic element for playback.

12. The system of claim 8, wherein the input device enables filtering the plurality of groups to a subset of the plurality of groups before enabling the user to select a graphic element for playback.

13. The system of claim 8, wherein the multimedia files include podcasts and the groups represent keyword groupings of podcasts.

14. The system of claim 8, wherein the set of multimedia files includes all multimedia files in the of the selected particular group.

15. A system comprising:
means for storing multimedia files in a database, the multimedia files in the database being associated with a plurality of groups;
means for presenting a user with graphic elements, such that each graphic element represents a particular group of the plurality of groups;
means for enabling the user to select a graphic element for selecting a particular one of the plurality of groups of multimedia files associated with the selected graphic element; and
means for queuing a set of the multimedia files from the particular one of the plurality of groups of multimedia files associated with the selected graphic element for playback.
